(19) United States
(12) Patent Application Publication
(10) Pub. No.: US 2013/0081365 A1
(43) Pub. Date: Apr. 4, 2013

(54) Saddle for horses

(71) Applicant: PEDRO RUIZ DAIZ, Ciudad Autonoma De Buenos Aires (AR)

(72) Inventor: PEDRO RUIZ DAIZ, Ciudad Autonoma De Buenos Aires (AR)

(21) Appl. No.: 13/630,711

(22) Filed: Sep. 28, 2012

(30) Foreign Application Priority Data
Oct. 3, 2011 (AR) P 20110103665

(51) Int. Cl. B68C 1/02

(52) U.S. Cl. 54/44.5

(57) ABSTRACT

A saddle for horses which is adapted to the body of the equine by means of a set of pads comprising a structured filling with a spongy material of fibers and a layer of a neoprene material, where such set of pads homogeneously distribute strains and temperatures which are generated on the back of them, preventing possible fatigues and chronic pains caused by the weight of the horseman during and after a physical effort.

### STATE OF THE ART OF THE INVENTION

1. Field of the Invention

This invention relates to the field of equitation, more particularly to saddles for horses which have a set of pads resting on their withers, wherein each of the pads of such set of pads comprises a construction that enables the homogeneous distribution of strains and temperatures generated on the back of the animal.

Even when this description refers to a saddle as a unit, the invention is also applicable to pads and sets of pads that are manufactured and marketed as separate part of the saddle.

2. Description of the Prior Art

In order to better understand the object and scope of this invention, it is convenient to describe the current state of the art with regard to saddles for horses, more particularly, pads thereof which rest on the back of the animal and its influence over it.

In the first instance, pads of saddles are part thereof and comprise fillings which are arranged in different parts of the saddle, some of them on the sides and above it, intended for providing comfort to the horseman and others, having greater size, arranged on the bottom of the saddle, intended for better distributing the loads of the horseman on the back of the horse. The pad generally comprises a part coated with the leather used by the saddle and filled with a filling material such as wool or expanded polyurethane, which has demonstrated that it does not attain a correct distribution of the loads of the horseman on the back of the animal in an homogeneous way, nor a satisfactory temperature, causing for the equine a heterogeneity in the distribution of load, strains and heat, notably affecting it.

For a more accurate test of known conventional saddles, the inventor hereof has proceeded to carry out various field tests thereof in order to demonstrate the disadvantage of traditional constructions and the use of such polyurethane material in pads of conventional saddles. Therefore, 4 equines were used in sport jumping work and clinical aspects were assessed thereof, being healthy at the time of examination. A conventional saddle was used in two of them, while a saddle according to the invention was used in the other two equines. Next, reference will be made to the study with conventional saddles, while results belonging to the saddles of the invention shall be provided below, in the detailed description of the invention.

Conventional saddles presented pads constructed with a leather coating and simply filled with an expanded polyurethane material, with the saddle being in good conditions. A thermography and an algometry prior to the work were carried out on equines and animals were saddle up by the same horse caretaker. Immediately, they were mounted by the same horseman doing the same exercises during 30 minutes, which included 5-minute walking, 10-minute trotting rising both hands, 10-minute galloping with both hands, finishing with 5 minutes at a walking pace. Methodology used for testing on the 4 equines is as follows.

A first step comprised the thermography test of the equine. Then, a second step was carried out, during which previous algometry of points known as “triggers points” was carried out, that is, points defining areas located where soft tissue and muscle fibers are very sensitive to pain when pressure is applied over them, irradiating pain or sensation towards other specific parts of the body. A third step consisted of the thermography test of the saddle immediately post-mounting for finishing with a fourth step, which comprised a thermography test and algometry one hour post-mounting.

In such studies, it was observed that thermography in horses tested with conventional saddle showed significant thermal increases during the immediate period post-exercising, and regularization of thermal patterns was very slow, taking more than three hours for returning to normality. Furthermore, algometry values were increase in relation to the basal value one hour post-exercising, taking 3 hours its regularization. All this enable us to conclude that the bad distribution of loads on the animal affected it in an important way, not only generating pain but also more concentrated hot areas, which resulted in a low performance of the animal.

By virtue of the foregoing, it would be very convenient to have a new saddle whose pads may be formed and constructed in such a way that may enable the homogeneous distribution of loads, in order to prevent fatigues, and heterogeneity of the distribution of strains and temperature caused by the saddle and the horseman, thus allowing to optimize performance of sport horses and specially for that equine which may suffer from acute or chronic pain on its back.

### BRIEF DESCRIPTION OF THE INVENTION

It is therefore an object of this invention to provide a saddle that may enable to be adapted to the body of the equine by means of a set of pads which homogeneously distribute strains and temperatures which are generated on the back of the animal in order to prevent possible fatigues and chronic pains caused by the weight of the horseman during and after a physical effort.

It is still another object of this invention to provide a set of pads of saddles for horses, of the type which comprises two longitudinal parts separated and arranged in a parallel way, which rest on the horse withers, enabling that a frame of saddle be adapted to the body thereof, and to distribute through such pads, strains which are generated on the horse during and after a physical effort, wherein such pads comprise a filling made of spongy material, and coated with a laminar material such as leather and the like.

It is still another object of this invention to provide a saddle which comprises pads with a new construction including a spongy material comprising compressed synthetic wool dough, enclosed within the laminar material coating.

It is also another object of this invention to provide a saddle comprising pads with a new construction including a layer of a neoprene material arranged between the laminar material coating y the synthetic wool dough at least on an extent of the periphery of the pad which rests on the back of the animal.

### BRIEF DESCRIPTION OF THE DRAWINGS

For the purpose of greater clarity and understanding of the object of this invention, it has been illustrated in various figures, in which invention has been shown in one of the preferred embodiments, all as a way of example, wherein:

FIG. 1 shows a rear view of a conventional saddle of the prior art with a transversal cut of the right pad, where the filling of the pad is observed in detail.

FIG. 2 shows a view similar to that of FIG. 1 but in a saddle and pad according to this invention.

FIG. 3 shows a thermography performed on the back of the equine, prior to mounting by the horseman with the new saddle, and temperatures that it has at determined specific points, where it further shows for reference a side bar of the different levels of temperature with the corresponding tonalities in grayscale.

FIG. 4 shows a thermography performed on the back of the equine immediately after physical effort with the new saddle, observing temperature variations generated in relation to temperatures of FIG. 3 at such specific points, wherein it further shows for reference a side bar of the different levels of temperature with the corresponding tonalities in grayscale.

FIG. 5 shows a thermography performed on the back of the equine an hour after the physical effort with the new saddle, observing temperature variations in relation to temperatures of FIG. 3 at such specific points, wherein it further shows for reference a side bar of the different levels of temperature with the corresponding tonalities in grayscale.

FIG. 6 shows a thermography performed on the back of the equine, prior to mounting by the horseman with the conventional saddle and temperatures which it has at determined specific points, wherein it further shows for reference a side bar of the different levels of temperature with the corresponding tonalities in grayscale.

FIG. 7 shows a thermography performed on the back of the equine immediately after physical effort with the conventional saddle, observing temperature variations generated in relation to temperatures of FIG. 6 at such specific points, wherein it further shows for reference a side bar of the different levels of temperature with the corresponding tonalities in grayscale.

FIG. 8 shows a thermography performed on the back of the equine an hour after the physical effort, with the conventional saddle, observing temperature variations in relation to temperatures of FIG. 6 at such specific points, wherein it further shows for reference a side bar of the different levels of temperature with the corresponding tonalities in grayscale.

FIG. 9 shows a thermography performed on a lower plant view of a new saddle, observing the homogeneous distribution of temperature generated thereon, where it further shows for reference a side bar of the different levels of temperature with the corresponding tonalities in grayscale.

FIG. 10 shows thermography performed on a lower plant view of the conventional saddle, observing the heterogeneous distribution of temperature generated thereon, where it further shows for reference a side bar of the different levels of temperature with the corresponding tonalities in grayscale.

### DETAILED DESCRIPTION OF THE INVENTION

Referring now to figures, we note that the invention consists of a saddle for equines which is provided, as it will be seen, with a novel construction of a set of pads which rest on the withers of the animal and which distribute strains and temperatures generated on the back of the animal homogeneously so as not to cause fatigues or chronic pains on it, caused by the weight of the horseman during and after a physical effort. Even when this description and claims refer to a set of pads of saddles for horses, it should be clear that this must be understood as inclusive of any saddle or arrangement that may require them.

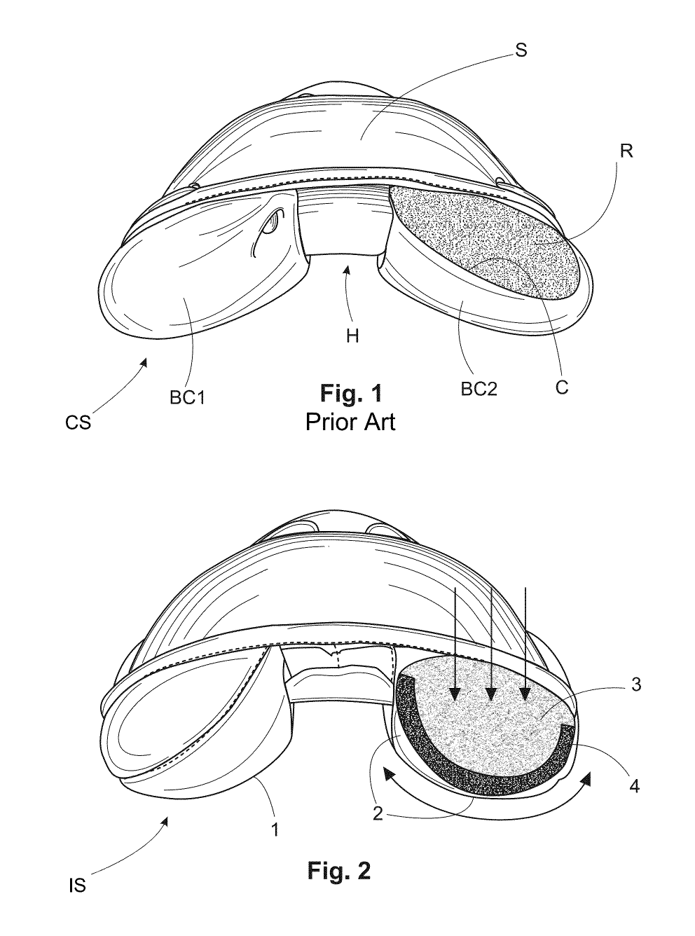

In order to better understand the invention, firstly we will refer to FIG. 1 which shows a conventional saddle with pads constructed according to the prior art. Conventional saddle, indicated with the general reference CS is viewed from the rear part thereof, and is provided with conventional pads BC1 and BC 2, one on the left and the other on the right of the saddle leaving a central void central H between both of them for better fitting to the back of the animal, as it is already known. The upper part S is where the horseman will be seated and it can be also constructed in a conventional way. F1 and F2 indicate the corresponding left and right flaps which fall on both sides of the animal and which are partly shown. The set of lower pads BC, which rest on the back of the horse, are made up of with the same coating as the saddle, for example leather, indicated by means of reference C and comprise a filling R made of a material known as expanded polyurethane.

The saddle IS of the invention such as is shown in FIG. 2, also has a set of pads (1) comprising two longitudinal parts separated and arranged in a parallel way, which rest on the horse withers enabling that a frame de saddle be fitted to the body of animal and which distribute strains y temperatures which are generated on the horse during and after a physical effort. According to the invention, such pads (1) comprise a novel construction consisting of a filling made of spongy material, and they are coated with a laminar material (2) such as leather and the like. Such spongy material comprises synthetic wool dough (3) which is compressed, and enclosed within the laminar material coating (2). More particularly, such synthetic wool (3) comprises semi-siliconized fleece and is formed by hollow polyester fibers which may be siliconized or not, being preferably a mix of both in equal or similar percentages. In turn, the value of the length cut if such fiber ranges between 4 mm to 8 mm, preferably form 6 mm, and choosing for the invention a fiber of 6 denier, selected from a group between 6, 10 and 15 denier.

On the other hand, such pad (1) has a layer of a neoprene type material (4) arranged between the coating of laminar material (2) and the synthetic wool dough (3) at least on an extent of the periphery of the pad (1) which rests on the back of the animal, such as is illustrated in FIG. 2. However, such extent of the periphery of the pad (1) occupied by the neoprene layer (4) may have an angle covering from at least 180° up to an angle of 360°. Furthermore, such neoprene material (4) comprises a material known in the market as “B-Foam” type, which is composed of a 70 percent of nitrile butadiene rubber, known as “NBR” coming from the English term “Nitrile Butadiene Rubber” and a 30 percent of neoprene. Such “NBR” is a family of unsaturated copolymers of 2 propene-nitriles and monomers of various butadiene, where physical and chemical properties depend on the composition rate of nitrile in the polymer, being a material flexible and resistant to certain chemicals. Furthermore, such layer of neoprene is coated by a nylon type material providing a total thickness of between 3 mm to 7 mm, preferably of 4 mm. The neoprene used for the invention, is a commercial name of the firm “DU PONT”, where such neoprene comprises a family of synthetic rubbers based on the chloroprene polymer, giving a material resistant to damages caused by flexion and torsion.

Preferably, such material made of synthetic wool (2) is free in relation to such layer of neoprene material (4) by means of an adhesive, and in turn, such layer of neoprene (4) is adhered to such coating laminar material (2) by means of an adhesive. Of course, such synthetic wool may have some degree of adherability on such neoprene material.

In FIG. 2, it is also shown a plurality of downward vertical and horizontal arrows with an upward curved development indicating the movement direction of such synthetic wool (3) and neoprene layer (4) due to the compression force generated by the weight and impacts of the horseman.

### Tests

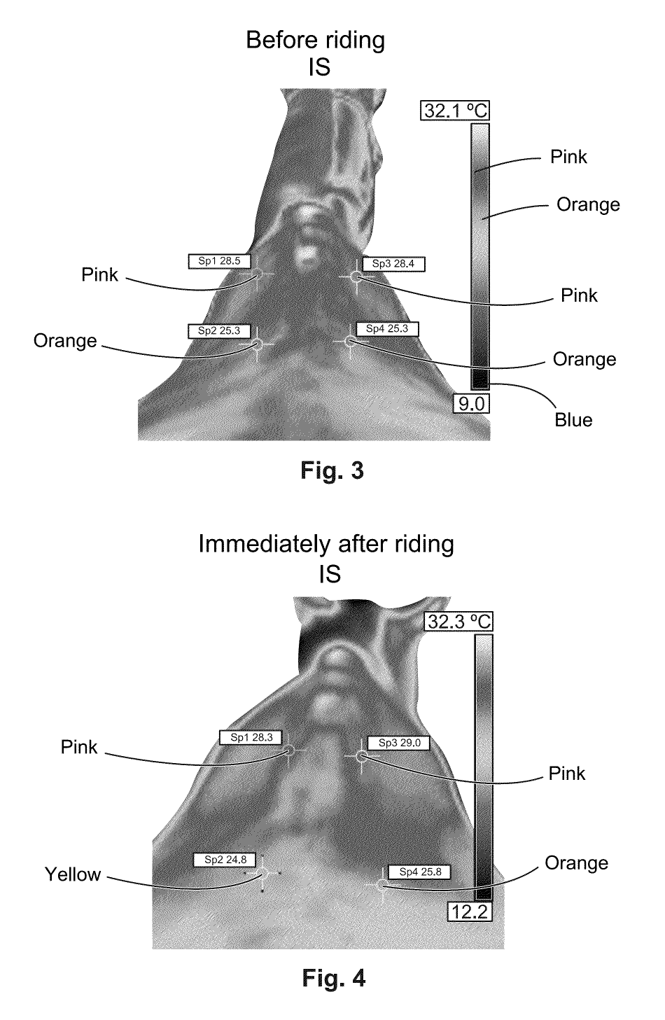

For the purpose of greater clarity of this invention, an essay has been performed, which has been previously described in connection with prior art and which will be described next in relation to the new saddle. Thermographies performed of FIGS. 3 to 10 are accompanied by a side bar with different levels of temperature for reference with the corresponding tonalities in grayscale, with such tonalities being indicated in Figures with various colors for not causing confusions.

As a way of simplification and for the purpose of not extending in repetitions, the number of equines ha been reduced to 4 to 2 in the following detailed description of the test, using the new saddle in the first of them “Babilonia” and the conventional saddle in the second “Grifa”. For the first equine “Babilonia”, we have proceeded with the following methodology.

New Saddle in “Babilonia”:

A first step comprised the thermography test of the equine, such as it is shown in FIG. 3, with temperatures at the specific points indicated in Figure being the following:

Sp1: 28.5°
Sp2: 25.3°
Sp3: 28.4°
Sp4: 25.3°

A second step consisted of carrying out the previous algometry of “triggers points”, resulting in a negative algometry with more than 14 kg-cm2.

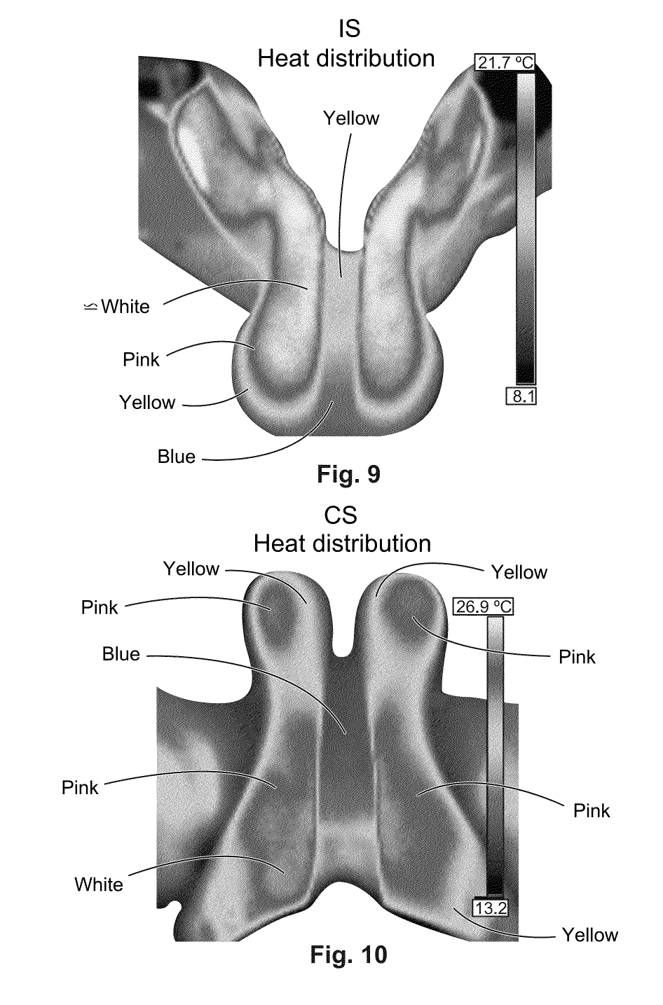

A third step consisted of the thermography test of the back of the animal and of the saddle, immediately post-mounting, such as it is shown in FIG. 4 for the back, and FIG. 9, for the saddle, with temperatures at the specific points indicated in FIG. 4, being the following:

Sp1: 28.3°
Sp2: 24.8°
Sp3: 29.0°
Sp4: 25.8°

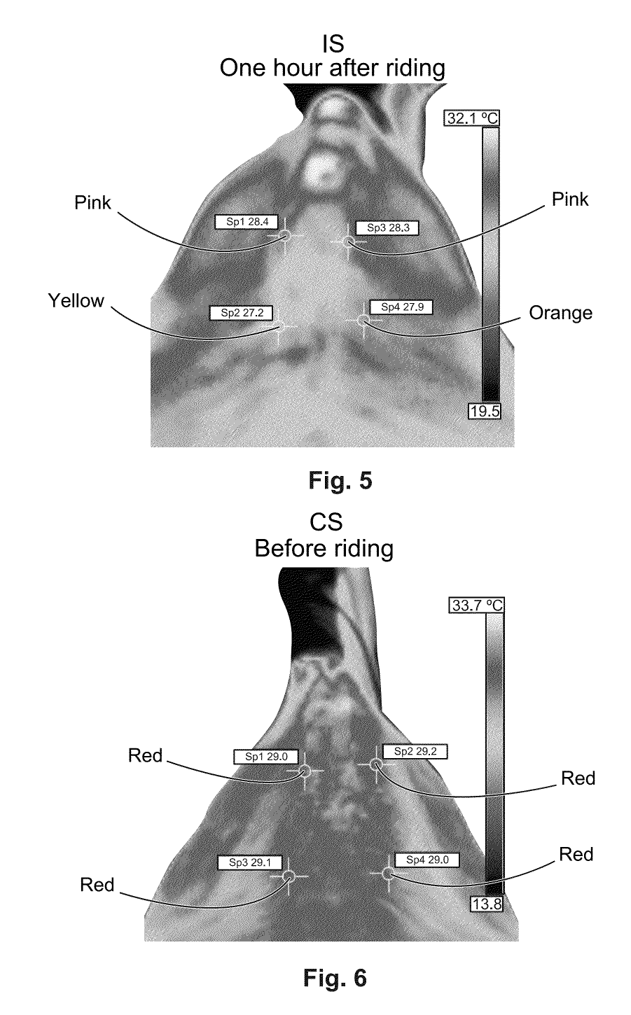

A fourth step, which comprised a thermography test and algometry of the back one hour post-mounting, such as it is shown in FIG. 5, resulted in a negative algometry with more than 14 kg-cm2, with temperatures at the specific points indicated in FIG. 5, being the following:

Sp1: 28.4°
Sp2: 27.2°
Sp3: 28.3°
Sp4: 27.9°

Conventional Saddle in “Grifa”: For the second equine “Grifa”, we have proceeded with the following methodology.

A first step comprised the thermography test of the equine, such as it is shown in FIG. 6, with temperatures at the specific points indicated in FIG. 6, being the following:

Sp1: 29.0°
Sp2: 29.2°
Sp3: 29.1°
Sp4: 29.0°

A second step consisted of carrying out the previous algometry of “triggers points”, resulting in a normal algometry with more than 14 kg-cm2.

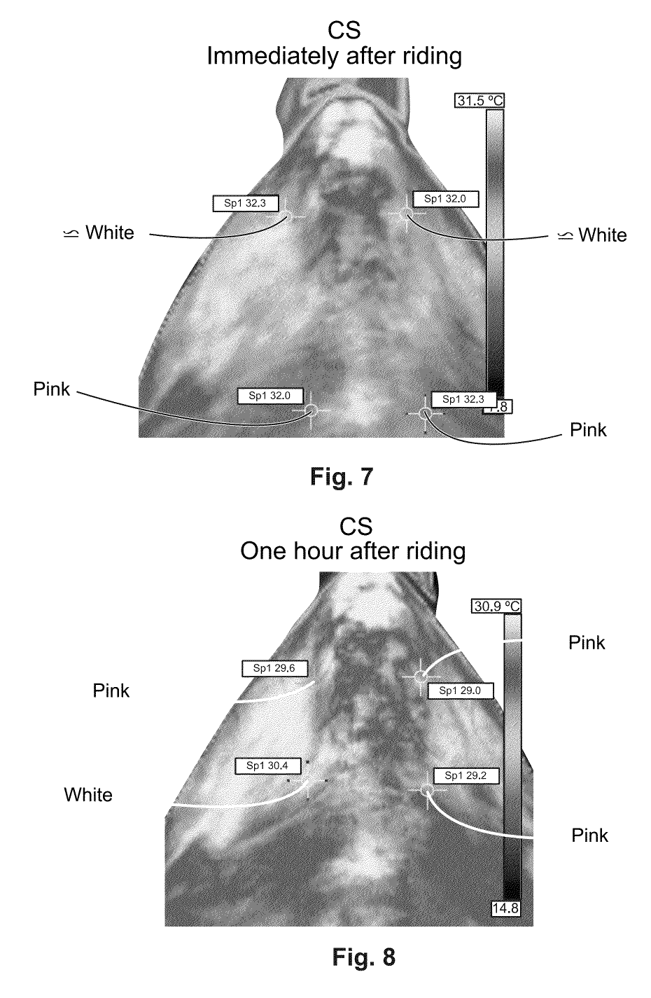

A third step consisted of the thermography test of the back of the animal and of the saddle, immediate post-mounting, such as it is shown in FIG. 7 for the back, and FIG. 10, for the saddle, with temperatures at the specific points indicated in FIG. 7, being the following:

Sp1: 32.3°
Sp2: 29.2°
Sp3: 32.0°
Sp4: 32.3°

A fourth step, which comprised a thermography test and algometry of the back one hour post-mounting, such as it is shown in FIG. 8, resulted in a positive algometry with less than 9 kg-cm2, with temperatures at the specific points indicated in Figure, being the following:

Sp1: 29.6°
Sp2: 29.0°
Sp3: 30.4°
Sp4: 29.2°

In FIGS. 9 and 10, a comparison in distribution of heat between the new saddle and the conventional saddle can be seen respectively, observing the homogeneous distribution of heat in the new saddle of FIG. 9, and the heterogeneous distribution of heat, with areas of heat concentration, in the conventional saddle of FIG. 10.

In turn, in such studies it was observed that thermography in horses tested with the new saddle has shown poorly significant thermal increases during the immediate post-exercising period, and regularization of thermography patterns was re-established during the first hour post-working. Furthermore, algometry values were not modified in relation to the basal value one hour post-exercising.

On the other hand, thermography in horses tested with conventional saddle has shown significant thermal increases during the immediate post-exercising period, and regularization of thermal patterns was very slow, taking more than three hours for returning to normality. Furthermore, algometry values were increased in relation to the basal value one hour post-exercising, with its regularization taking three hours.

It can be concluded that distribution of weight through the new saddle, has been more physiologic than in the conventional saddle. In turn, the use of spongy material of the type which comprises such synthetic wool (3) and the layer of neoprene material (4) with the correct manufacture of the new saddle, enable a proper decomposition of compressing forces on the back of the equine, generated by the weight of the horseman. Being the saddle of the invention recommendable for the use in sport horses for optimizing performance and specially for those equines which suffer from acute or chronic pain in their back.

1. A saddle for horses, of the type which comprises a frame having at least two longitudinal pads separated and arranged in a parallel way, which rest on the horse withers, allowing to be fitted to its body, and to distribute through such pads, Strains generated on the horse during and after a physical effort, wherein such pads comprise a filling made of spongy material, and coated with a laminar material such as leather and the like, each of such pads being:
such spongy material comprises a compressed synthetic wool dough, enclosed within the laminar material coating,
a layer of a neoprene material being arranged between coating of laminar material and the synthetic wool dough at least on an extent of the periphery of the pad which rests on the back of the animal.

2. A saddle according to claim 1, wherein such material made of synthetic wool is affixed to such neoprene material by means of an adhesive.

3. A saddle according to claim 1, wherein such extent of the periphery of the pad occupied by the neoprene layer covers a radius of at least 180°.

4. A saddle according to claim 1, wherein such extent of the periphery of the pad occupied by the neoprene layer covers a radius of 360°.

5. A saddle according to claim 1, wherein such neoprene is affixed to such coating laminar material by means of an adhesive.

6. A saddle according to claim 1, wherein such material made of synthetic wool is semi-siliconized fleece.

7. A saddle according to claim 6, wherein such semi-siliconized fleece comprises a mix of hollow siliconized and non-siliconized fibers, wherein the cut in length is of 6 mm, and where such fibers are of 6 denier.

8. A saddle according to claim 7, wherein such mix comprises 50 percent of siliconized fiber and 50 percent of non-siliconized fiber.

9. A saddle according to claim 1, wherein such neoprene material comprises 70 percent de nitrile butadiene rubber “NBR”, and a 30 percent of neoprene.

10. A saddle according to claim 9, wherein such layer of neoprene material comprises two layers of nylon coating, and has a thickness of 4 mm.
